(19) United States
(12) Patent Application Publication
(10) Pub. No.: US 2014/0317970 A1
(43) Pub. Date: Oct. 30, 2014

(54) PERSONAL LINEN IDENTIFICATION

(71) Applicant: Kathlyn Ann Moore, Lake Worth, FL (US)

(72) Inventor: Kathlyn Ann Moore, Lake Worth, FL (US)

(21) Appl. No.: 14/263,843

(22) Filed: Apr. 28, 2014

Related U.S. Application Data
(60) Provisional application No. 61/854,711, filed on Apr. 29, 2013.

(51) Int. Cl. G09F 3/04

(52) U.S. Cl. CPC G09F 3/04; G09F 2003/0282
USPC 40/360; 40/661

(57) ABSTRACT

Arrangements relate to identification tags, systems, kits and methods for personal linens. An identification tag can include a main body element and an attachment element operatively connected to the main body element. The main body element includes a recess. The recess includes a sidewall. In some instances, the recess can extend to a depth in a thickness of the main body element, forming a bottom surface. The recess opens to a side of the main body element. The attachment element can be configured to attach to itself or to the main body element so as to form a loop. The identification tag can include a window element retainably engaged in the recess. The identification tag can be attached to the personal linen by the attachment element. The attachment element can engage an attachment point of the personal linen. The personal linen can be a type of towel.

### CROSS-REFERENCE TO RELATED APPLICATIONS

This application claims the benefit of U.S. Provisional Application No. 61/854,711, filed on Apr. 29, 2013, which is incorporated herein by reference in its entirety.

### FIELD

Arrangements relate in general to personal linens and, more particularly, to the identification of personal linens.

### BACKGROUND

There are various situations in which two or more people may share communal areas or facilities. For instance, family members or roommates may share a bathroom in a dwelling. In such cases, towels or other personal linens may be shared, whether intentionally or unintentionally, by two or more people. The sharing towels or other personal linens can appreciably increase the risk of contracting and/or spreading bacteria, germs, viruses, diseases, infections and/or parasites.

There are various ways for marking towels to reduce the likelihood that they are shared. Some of these methods are temporary in nature, such as by attaching a paper name tag to a towel using safety pins, plastic or metal alligator clips, paperclips, or magnets. However, most of these manners of attachment are likely to damage the towel, leaving holes and/or snags in the material. Further, some of these methods may not be safe for close contact with human skin. In some cases, a sticker is attached to the towel. However, the sticker may leave an adhesive residue behind, creating an unsightly appearance and possibly damaging the towel. Further, some of the methods are permanent in nature, such as writing a name with permanent marker or by embroidering or sewing a name directly into the towels or other personal linen. However, such methods may damage the material, are expensive and/or limit options for future marking.

### SUMMARY

In one respect, arrangements relate to an identification tag. The identification tag includes a main body element. The main body element can have an associated thickness. The main body element includes a recess. The recess can open to a side of the main body element and can extend into the thickness of the main body element. The recess includes a sidewall. In one or more arrangements, the recess can extend to a depth in the thickness of the main body element. In such case, the recess can have a bottom surface. In other arrangements, the recess can extend through the entire thickness of the main body element.

The identification tag further includes an attachment element. The attachment element is operatively connected to the main body element. The attachment element is configured to attach to itself and/or to the main body element so as to form a loop. In one or more arrangements, the attachment element includes a strap with at least one enlarged element provided thereon. In one or more arrangements, the attachment element includes a strap configured with connectors to allow the strap to be attached to itself or to the main body element.

In one or more arrangements, the attachment element can be a separate piece from the main body element. In one or more arrangements, the attachment element and the main body element can be a unitary structure.

The identification tag also includes a window element. The window element is retainably engaged in the recess.

In one or more arrangements, the sidewall can be a first sidewall. In such case, the recess can further include a second sidewall. The first and second sidewalls can be configured to retainably engage the window element. The first and second sidewalls can be substantially parallel to each other. In one or more arrangements, the sidewall can include a receiving channel. A portion of the window element can be received in the receiving channel. The sidewall can include an inward protrusion. The window element can be retainably engaged in the recess by at least the protrusion.

The identification tag can further include one or more character elements. The character elements can be removably attached to the window element or a bottom surface of the recess.

In another respect, arrangements are directed to a linen identification system. The system can include a personal linen, which can be, for example, a towel. The system can further include an identification tag. The identification tag includes a main body element. The main body element has an associated thickness. The main body element includes a recess. The recess opens to a side of the main body element and extends into the thickness of the main body element. The recess includes a sidewall. In one or more arrangements, the recess can extend to a depth in the thickness of the main body element. In such case, the recess can have a bottom surface. In other arrangements, the recess can extend through the entire thickness of the main body element.

The identification tag can include an attachment element. The attachment element can be operatively connected to the main body element. The attachment element can be configured to attach to itself and/or to the main body element so as to form a loop. The attachment element is a separate piece from the main body element.

The identification tag can also include a window element. The window element can be retainably engaged in the recess.

The identification tag is attached to the personal linen by the attachment element. The attachment element engages an attachment point of the personal linen. In one or more arrangements, the attachment point can be an information tag provided on the personal linen. The information tag can be provided in the form of a loop that defines a passage. The attachment element of the identification tag can be received in the passage. In one or more arrangements, the attachment point can be a hole provided in the personal linen.

The linen identification system can further include one or more character elements. The one or more character elements can be removably attached to the window element or the bottom surface of the recess.

In still another respect, arrangements are directed to a linen identification kit. The linen identification kit can include a sheet that includes a plurality of character elements. The character elements can be configured to be removed from the sheet.

The linen identification kit can include an identification tag. The identification tag can include a main body element. The main body element can have an associated thickness. The main body element can include a recess. The recess opens to a side of the main body element. The recess extends into the thickness of the main body element. The recess includes a sidewall. In one or more arrangements, the recess can extend to a depth in the thickness of the main body element. In such case, the recess can have a bottom surface. In other arrangements, the recess can extend through the entire thickness of the main body element.

The identification tag can include an attachment element. The attachment element is operatively connected to the main body element. The attachment element is configured to attach to itself and/or to the main body element so as to form a loop.

The character elements are configured to be removably attached to the identification tag.

The linen identification kit can further include a window element. The recess can be configured to retainably engage the window element.

In one or more arrangements, the identification tag can be a first identification tag, and the linen identification kit can further include a second identification tag. The second identification tag can be different from the first identification tag in one or more respects. As an example, in one or more arrangements, the first and second identification tags can be different colors and/or different shapes.

The second identification tag can include a main body element. The main body element can include a recess. The recess can open to a side of the main body element. The recess can extend into the thickness of the main body element. The recess can include a sidewall. In one or more arrangements, the recess can extend to a depth in the thickness of the main body element. In such case, the recess can have a bottom surface. The second identification tag can include an attachment element. The attachment element can be operatively connected to the main body element. The attachment element can be configured to attach to itself and/or to the main body element so as to form a loop.

### BRIEF DESCRIPTION OF THE DRAWINGS

FIG. 1 is an example of an identification tag, showing a first side of the identification tag.

FIG. 2 is an example of an identification tag, showing a second opposite side of the identification tag.

FIG. 3 is an example of an identification tag, showing a side view of the identification tag.

FIG. 4 is an example of an identification tag, showing an exploded view of the identification tag.

FIG. 5 is an example of an identification tag, showing a plurality of character elements attached to the identification tag to spell a name.

FIG. 6 is an example of a sheet of a plurality of individual character elements.

FIG. 7 is a cross-section of a portion of the identification tag of FIG. 4 viewed along line 7-7, showing an example of retainable engagement between a window element and a main body element of the identification tag.

FIG. 8 is a cross-section of a portion of the identification tag of FIG. 4 viewed along line 8-8, showing an example of retainable engagement between a window element and a main body element of the identification tag.

FIG. 9 is an example of an identification tag, showing a separate retainer element.

FIG. 10 is an example of an identification tag, showing an example of a separate retainer element and two holes provided in the main body element.

FIG. 11 is an example of an identification tag attached to a personal linen.

FIG. 12 is an example of a portion of a personal linen adapted to facilitate attachment of an identification tag thereto.

FIG. 13 is an example of an identification tag kit.

### DETAILED DESCRIPTION

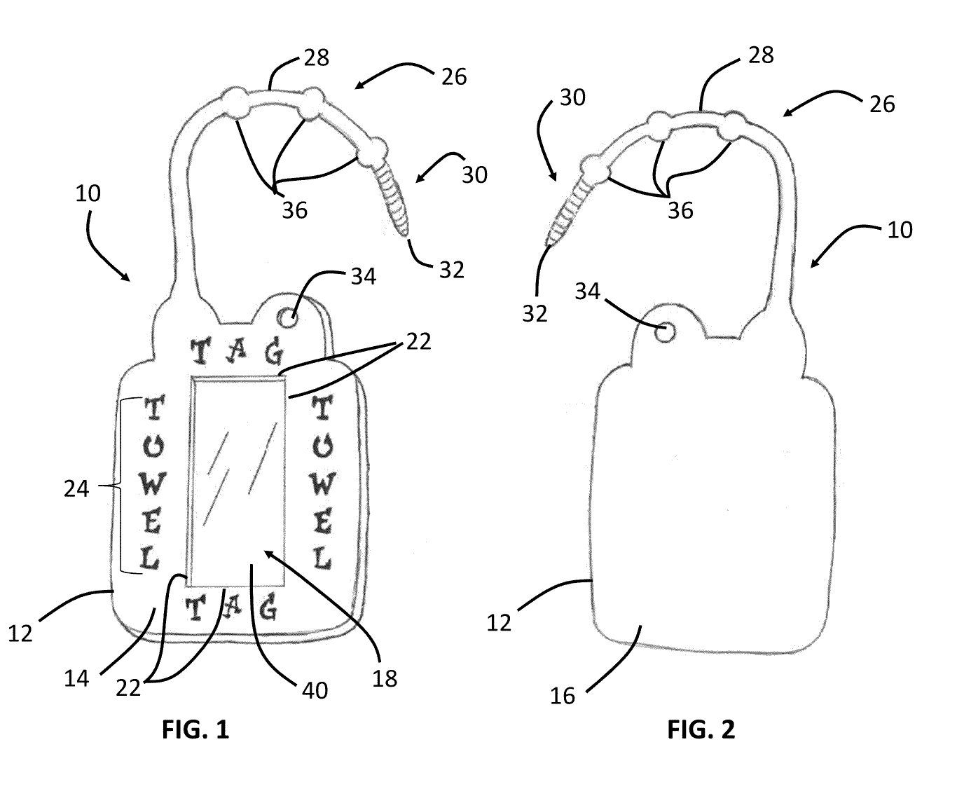

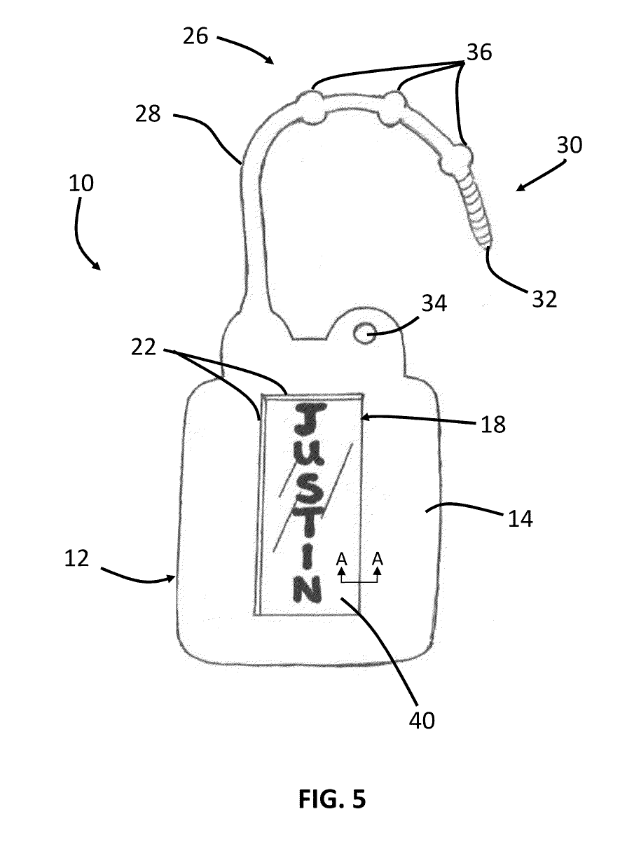

Arrangements described herein relate to systems, methods, apparatus and/or kit for use in connection with identifying personal linens and/or other items. Detailed embodiments are disclosed herein; however, it is to be understood that the disclosed embodiments are intended only as exemplary. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of embodiments and aspects herein. Arrangements are shown in FIGS. 1-13, but the embodiments are not limited to the illustrated structure or application.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features. In addition, numerous specific details are set forth in order to provide a thorough understanding of the embodiments described herein. However, it will be understood by those of ordinary skill in the art that the embodiments described herein can be practiced without these specific details.

Referring to FIGS. 1-3, one or more arrangements herein can include an identification tag 10. The identification tag 10 can include a main body element 12. The main body element 12 can have any suitable size and/or shape. For instance, the main body element 12 can be substantially rectangular in confirmation, as is shown in FIGS. 1-3. As used herein, the term “substantially” includes exactly the term it modifies and slight variations therefrom. Thus, the term “substantially rectangular” means exactly rectangular and slight variations therefrom. However, other shapes for the main body element 12 are possible. For instance, the main body element 12 can be substantially triangular, substantially square, substantially polygonal, substantially trapezoidal, substantially circular, substantially oval, substantially parallelogram, or irregular, just to name a few possibilities. In some implementations, the main body element 12 can be shaped like a thing or object. For instance, the main body element 12 can be shaped like an animal, sports-related item, or landmark, just to name a few possibilities.

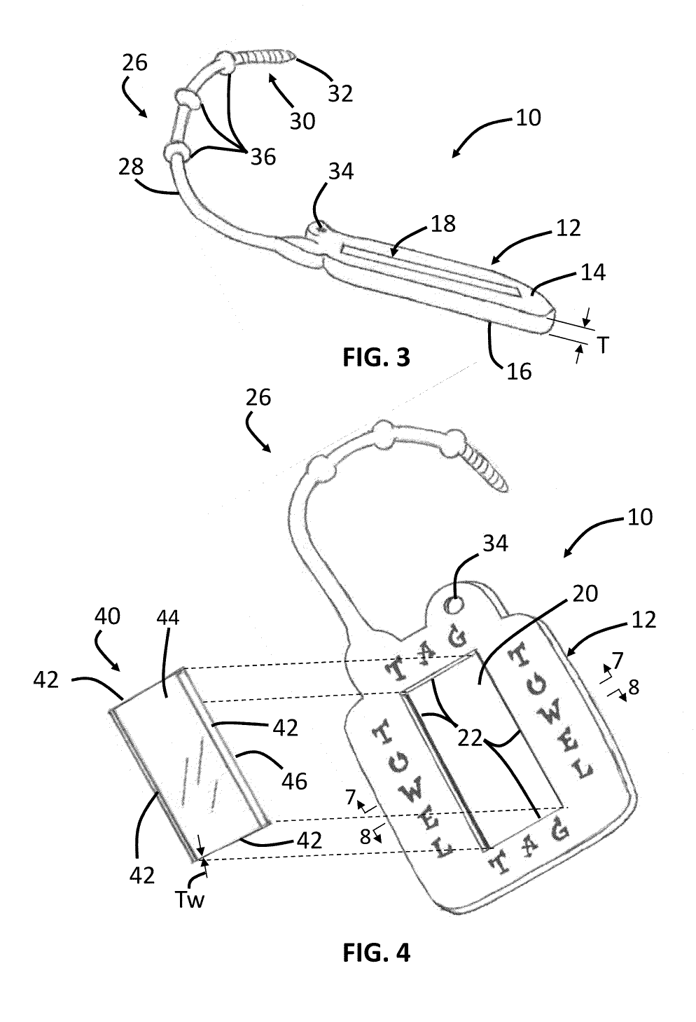

The main body element 12 can have a first side 14 and a second side 16. The first side 14 and the second side 16 can be substantially parallel to each other. In some instances, the first side 14 and the second side 16 may be non-parallel to each other. The first side 14 and/or the second side 16 can have a substantially planar surface, as is shown in FIGS. 1-3. Alternatively, the first side 14 and/or the second side 16 can be non-planar or can include one or more non-planar features. The main body element 12 can have an associated thickness T (FIG. 3). The thickness T can be substantially constant across the main body element 12. Alternatively, the thickness T can vary in or more portions of the main body element 12.

The main body element 12 can include a recess 18. In one or more implementations, the recess 18 can extend at a depth into the thickness T of the main body element 12. The recess 18 can include a bottom surface 20 and one or more sidewalls 22. The recess 18 can open to the first side 14 of the main body element 12. In some arrangements, the recess 18 can extend through the entire thickness T of the main body element 12.

The recess 18 can have any suitable size and/or shape. While FIGS. 1-3 show a substantially rectangular recess 20, it will be understood that arrangements are not limited to this geometry. Indeed, the recess 20 can be, for example, substantially triangular, substantially square, substantially polygonal, substantially trapezoidal, substantially circular, substantially oval, substantially parallelogram, or irregular, just to name a few possibilities.

In some arrangements, there can be a plurality of recesses. In such case, the plurality of recesses can be substantially identical to each other. Alternatively, one or more of the recesses can be different from the other recesses in one or more respects. The plurality of recesses can be provided on the main body element 12 in any suitable arrangement.

In one or more arrangements, the main body element 12 can include any suitable indicia 24 thereon. For instance, one or more names, full names, nicknames, monograms, initials, letters, words, trademarks, logos, characters, designs, symbols, decorations and/or other elements can be provided on the main body element 12, as is shown in FIG. 1. The indicia 24 can be provided on the first side 14 and/or the second side 16 of the main body element 12. The indicia 24 can be provided on the main body element 12 in any suitable manner, such as by molding, engraving, embossing, etching or stamping, just to name a few possibilities. The indicia 24 can be raised or recessed relative to the respective side of the main body element 12 on which it is provided.

The identification tag 10 can be configured to retainably engage an item, such as a personal linen. FIG. 11 shows an example in which the identification tag 10 retainably engages a portion of a personal linen 56, such as a towel 57. As used herein, “personal linen” is any material that is intended to come into contact with at least a portion of the body of a human or animal. Examples of personal linens include bath towels, wash cloths, hand towels, beach towels, foot towels, sports towels, and clothes.

Any suitable manner of retainable engagement can be provided between the identification tag 10 and the personal linen. For instance, the identification tag 10 can include an attachment element 26. The attachment element 26 can be any structure configured to facilitate the removable attachment of the identification tag 10 to a personal linen.

In one implementation, the attachment element 26 can include a strap 28. The strap 28 can be elongated structure. The strap 28 can have any suitable cross-sectional shape. For instance, the cross-sectional shape of the strap 28 can be substantially circular. However, it will be understood that other cross-sectional shapes are possible. The strap 28 can include an end portion 30 culminating in a distal end 32. In one or more arrangements, the end portion 30 of the strap 28 can be tapered.

The attachment element 26 and/or the main body element 12 can be configured to permit the attachment element 26 to retainably engage the main body element 12. In one implementation, the main body element 12 can further include a hole 34, and the strap 28 can include one or more enlarged elements 36. An “enlarged element” is any local area of increased thickness of the strap 28. The enlarged elements 36 can have any suitable form. In one arrangement, the enlarged elements 36 can be substantially spherical, as is shown in FIGS. 1-3. However, it will be understood that the enlarged elements 36 can have other shapes and/or forms.

The hole 34 can be sized, shaped and/or otherwise configured to receive the strap 28. The enlarged elements 36 can be larger than the size of the hole 34. As an example, when the enlarged elements 36 are substantially spherical, the enlarged elements 36 can have an associated diameter. When the hole 34 is substantially circular, the hole can have an associated diameter. The diameter of the enlarged elements 36 can be slightly greater than the diameter of the hole 34.

The enlarged elements 36 can pass through the hole 34 upon application of sufficient force to the enlarged elements 36 and/or main body element 12. In one implementation, sufficient force can be applied by a user by pressing or pushing with one or more fingers and/or one or more thumbs. The retainable attachment between the strap 28 and the hole 34 can be adjusted by selectively forcing a desired quantity of enlarged elements 36 through the hole 34 as described above. The enlarged elements 36 can be passed through the hole 34 in two opposing directions. Thus, if a user wishes to disengage the strap 28 from the main body element 12 and/or if a user wishes to adjust the retainable engagement in the opposite direction, the user can force the enlarged elements 36 through the hole 34 in the opposite direction.

In one or more implementations, a single enlarged element 36 can be provided. In one or more implementation, a plurality of enlarged elements 36 can be provided along the length of the strap 28. In one arrangement there can be three enlarged elements 36, as is shown in FIGS. 1-3. However, it will be understood that embodiments are not limited to this arrangement. Indeed, the quantity of enlarged elements 36 can be fewer or greater than three. When a plurality of enlarged elements 36 are provided, the enlarged elements 36 can have any suitable spacing. For instance, the enlarged elements 36 can be substantially equally spaced along the length of the strap 28. Alternatively, the enlarged elements 36 can be unequally spaced along the length of the strap 28.

In the case of a plurality of enlarged elements 36, the enlarged elements 36 can be substantially identical to each other. Alternatively, one or more of the enlarged elements 36 can be different from the other enlarged elements 36 in one or more respects, including, for example, size and/or shape.

The attachment element 26 can be operatively connected to the main body element 12. The term “operatively connected” can include direct or indirect connections, including connections without direct physical contact. Various example of the attachment element being operatively connected to the main body element 12 will now be provided. It will be understood that these examples are provided to facilitate the description and that embodiments are not limited to these examples. In some arrangements, the main body element 12 and the attachment element 26 can be formed as a single piece, such as by injection molding or other suitable process. Thus, the main body element 12 and the attachment element 26 are a unitary structure. In other arrangements, the main body element 12 and the attachment element 26 can be formed as separate pieces that are subsequently joined and/or engaged in any suitable manner, such as by one or more adhesives, one or more fasteners, and/or one or more forms of mechanical engagement.

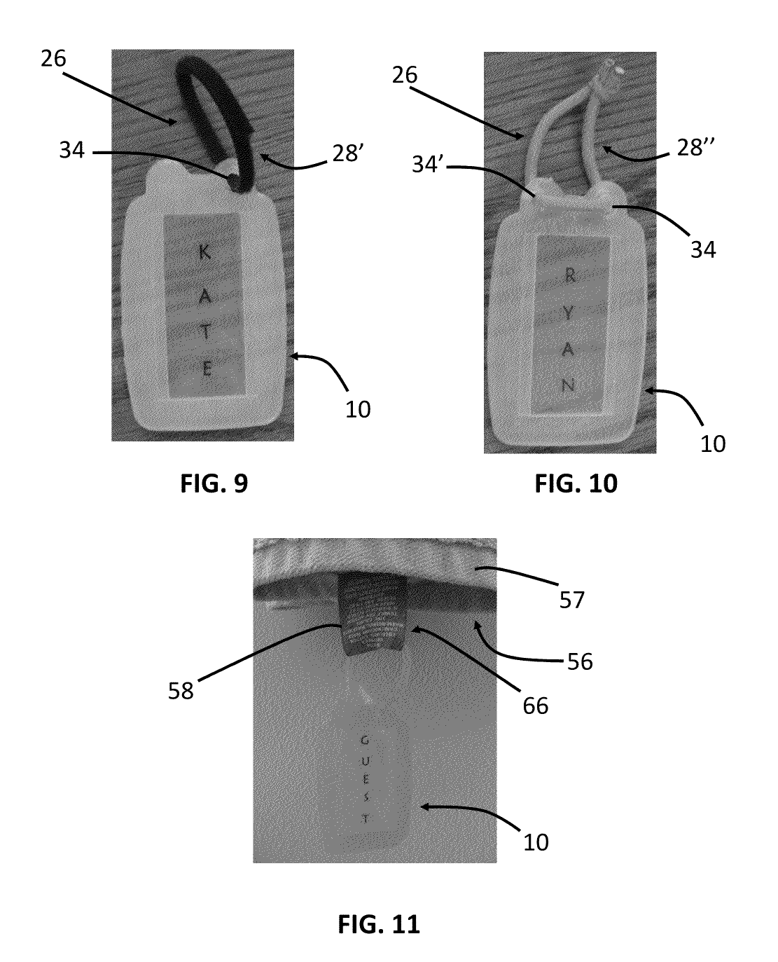

FIGS. 9 and 10 show examples in which the attachment element 26 is formed as a separate piece. In the arrangement shown in FIG. 9, the attachment element 26 can be a strap 28′ that is configured to include any suitable fasteners thereon. As an example, the strap 28′ can include hook and loop fasteners. For instance, at least a portion of one side of the strap 28′ can include hooks, and at least a portion of an opposite side of the strap 28′ can include loops. The strap 28′ can be passed through the hole 34 in the main body element 12. Portions of the strap 28′ can be brought into contact with itself such that there is engagement between the hooks and the loops. In the arrangement shown in FIG. 10, a strap 28″ can be passed through two holes 34, 34′ in the main body element 12. Portions of the strap 28″ can be brought into engagement with itself, such as by tying the portions in a knot. It should be noted that, while FIG. 10 shows an arrangement in which there are two holes 34, 34′, it will be understood that a single hole can be provided or that more than two holes can be provided.

The identification tag 10 can be made of any suitable material. The material can have any suitable characteristics. For instance, the material can be relatively soft to human touch, smooth, resilient, and/or flexible. The material can have one or more characteristics to provide comfort or avoid discomfort when contacting human skin. In one or more implementations, the identification tag 10 can be made of thermoplastic polyurethane. In one or more implementations, the identification tag 10 can be made of flexible silicone, nylon, or resins. Further, the identification tag 10 can be made of plastics, acrylics and/or other rigid materials by attaching to and hanging from a separate looped attachment element. The looped attachment element can be a stretchable and/or elastic cord or strap (see, e.g. strap 28″ in FIG. 10). Alternatively or in addition, the looped attachment can be a hook and loop strip that forms a loop (see, e.g., strap 28′ in FIG. 9). In one or more implementations, the identification tag 10 can be made of aluminum or other suitable metal. In one or more implementations, the identification tag 10 can be made of U.S. Food and Drug Administration food grade silicone.

In some arrangements, the main body element 12 and the attachment element 26 can be made of the same material. In other arrangements, the main body element 12 and the attachment element 26 can be made of different materials.

The identification tag 10 can be provided in one or more colors. The identification tag 10 can be transparent or translucent. In some instances, the identification tag 10 can be opaque.

In one or more arrangements, the identification tag 10 can include a window element 40. The window element 40 can have one or more sides 42. The window element 40 can have a first face 44 and a second face 46. The first face 44 and the second face 46 can be substantially parallel to each other. In some instances, the first face 44 and the second face 46 may be non-parallel to each other. The window element 40 can have an associated thickness Tw (FIG. 4). The thickness Tw can be substantially constant across the window element 40. Alternatively, the thickness Tw can vary in or more portions of the window element 40.

The window element 40 can have any suitable size and/or shape. For instance, the window element 40 can be substantially rectangular in confirmation, as is shown in FIGS. 1-3. However, other shapes for the window element 40 are possible. For instance, the window element 40 can be substantially triangular, substantially square, substantially polygonal, substantially trapezoidal, substantially circular, substantially oval, substantially parallelogram, or irregular, just to name a few possibilities. In some implementations, the window element 40 can be shaped like a thing or object. For instance, the window element 40 can be shaped like an animal, sports-related item, or landmark, just to name a few possibilities.

The window element 40 can be transparent or translucent. In some instances, the window element 40 can be opaque. The window element 40 can be made of any suitable material. In one implementation, the window element 40 can be made of a plastic material. The window element 40 can be flexible.

The window element 40 can be retainably engaged by the main body element 12. For instance, the window element 40 can be retainably engaged in the recess 18 of the main body element 12. “Retainably engaged” means held in place on the indicated element while permitting selective removal and/or re-engagement with the indicated element.

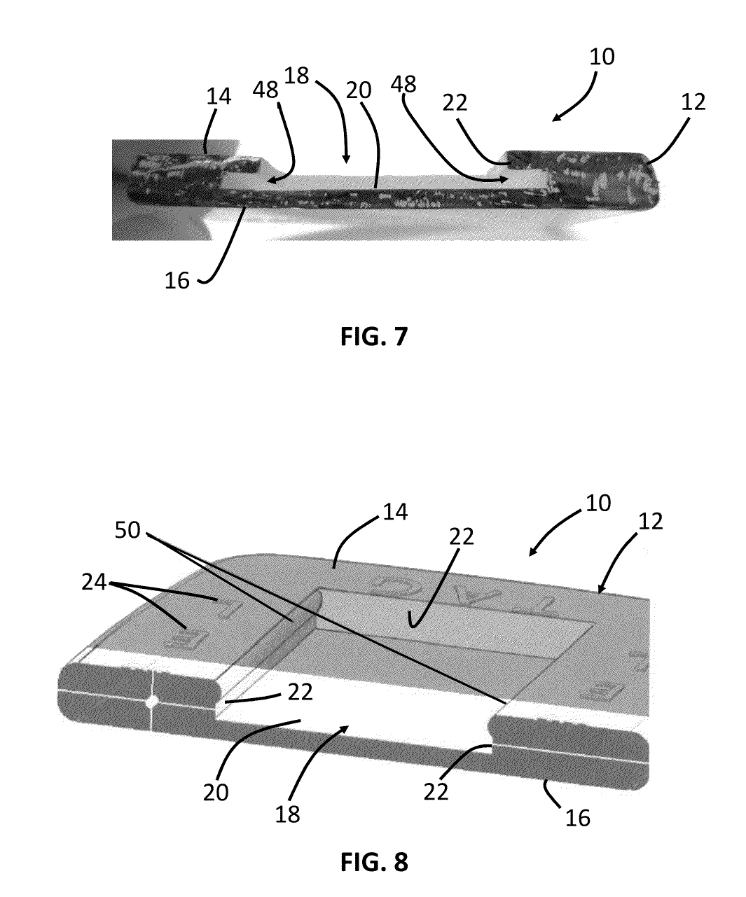

Any suitable form of retainable engagement can be provided. For instance, one or more of the sidewalls 22 of the recess 18 can be configured to retainably engage a respective side 42 of the window element 40. FIG. 7 shows an example in which one or more of the sidewalls 22 of the recess 20 can include a receiving channel 48. The channel 48 can be configured to receive at least a portion of a respective side 42 of the window element 40. The channel 48 can extend along the entire length of the respective sidewall 22. Alternatively, the channel can extend along at least a portion of the length of the respective sidewall 22 of the recess 18.

Another example of retainable engagement is shown in FIG. 8. As is shown, one or more of the side walls 22 of the recess 40 can include an inward protrusion 50. The protrusion 50 can have any suitable size, shape and/or configuration. The protrusion 50 can be provided at any suitable location. For instance, the protrusion 50 can be at or near the first surface 14 of the main body element 12, as is shown in FIG. 8. Thus, the window element 40 can be retained in the recess 18 by at least the protrusion 50.

The arrangements shown in FIGS. 7 and 8 are merely provided as examples; therefore, it will be understood that embodiments are not limited to these arrangements. Indeed, other manners of retainably engaging the window element 40 with the main body element 12 are possible. Moreover, arrangements can include combinations of these and other forms of retainable engagement.

In one or more arrangements, the window element 40 can be spaced from the bottom surface 20. In one or more arrangements, at least a portion of the window element 40 can directly contact the bottom surface 20. The window element 40 can be substantially parallel to the bottom surface 20. Alternatively, the window element 40 can be non-parallel to the bottom surface 20.

In one arrangement, a single side wall 22 of the recess 18 can be configured to retainably engage the window element 40. Alternatively, all of the side walls 22 of the recess 18 can be configured to retainably engage the window element 40. Still alternatively, a plurality of the side walls 22 of the recess 18 can be configured to retainably engage the window element 40. In one implementation, two of the side walls 22 of the recess 18 can be configured to retainably engage the window element 40. In such case, the two side walls 22 can be an opposing pair of the side walls 22, an example of which is shown in FIG. 8. Alternatively, the two side walls 22 can be an adjacent pair of side walls 22.

The identification tag 10 can be personalized in any suitable manner. For instance, a user can form one or more characters on the identification tag 10 using any suitable implement, such as a marker, permanent marker, pen, pencil or paintbrush. Alternatively, a user can apply individual characters to the identification tag 10. In one implementation, a sheet 60 including a plurality of individual character elements 62 can be provided. The sheet 60 can be a relatively thin mass or piece of material. The sheet 60 can have any suitable shape. In one or more arrangements, the sheet 60 can be substantially rectangular, but it will be understood that arrangements are not limited to this shape. The sheet 60 can be made of any suitable material, including, for example, paper and/or plastic, just to name a few possibilities.

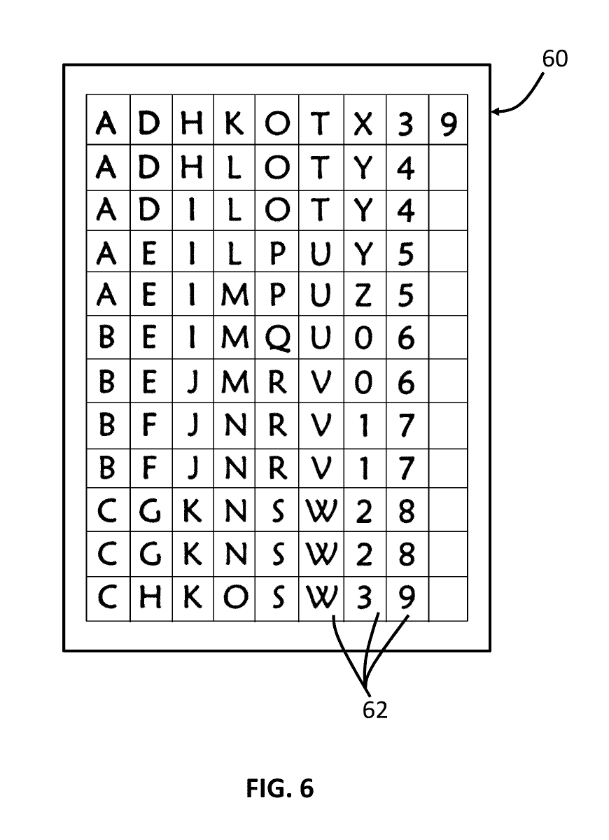

An example of such a sheet 60 is shown in FIG. 6. A plurality of preprinted characters elements 62 can be provided on the sheet 60. The character elements 62 can include one or more letters, one or more words, one or more abbreviations, one or more numbers, one or more shapes, one or more symbols, and/or one or more pictures, just to name a few examples. The character elements 62 can be made of any suitable material, such as vinyl.

The character elements 62 can be removably attached to one or more surfaces of the sheet 60 in any suitable manner. In one or more implementations, the character elements 62 can be attached to one or more surfaces of the sheet by, for example, static cling or adhesive. The individual character elements 62 can be separated from the sheet 60 (e.g. such as by peeling) for application to the window element 40 and/or the identification tag 10.

More particularly, the individual character elements 62 can be applied to the first and/or second side 14, 16 of the main body element 12. Alternatively or in addition, the individual character elements 62 can be applied to a portion of the recess 18. For instance, one or more character elements can be applied to the bottom surface 20 of the recess 18. In such case, the character elements 62 can be protected by the window element 40, which can cover the bottom surface 20. Still alternatively or in addition, the individual character elements 62 can be applied to the first and/or second face 44, 46 of the window element 40.

The individual character elements 62 can be attached to one or more of these surfaces in any suitable manner. More particularly, the individual character elements 62 can be removably attached to one or more of these surfaces in any suitable manner. In one implementation, the individual character elements 62 can be attached to one or more of these surfaces by static cling, thereby permitting reuse of the character elements 62 and facilitating the changing of and/or rearranging of the character elements 62. In other implementations, the individual character elements 62 can be attached to one or more of the noted surfaces by an adhesive.

It will be appreciated that the linen identification system and/or apparatus described herein can be provided as a kit. One example of a kit 70 is shown in FIG. 13. The kit 70 can include one or more identification tags 10 and/or one or more window elements 40. The quantity of identification tags 10 provided in the kit 70 can be equal to the quantity of window elements 40 provided in the kit 70. In some implementations, the kit 70 can include one or more items to personalize the identification tags 10. For instance, the kit 70 can include one or more sheets 60 of including a plurality of character elements 62. Alternatively or in addition, the kit can include a writing implement or other implement (not shown) configured to allow a user to form characters on the window element 40, the main body 12 and/or blank elements on the sheet 60. In some implementations, the kit 70 may also include an information sheet 72. The information sheet 72 can be one or more pieces of paper. The information sheet 72 can provide any suitable information, such as instructions on the assembly, use and/or care of the identification tags 10.

Now that the various aspects of the identification tag have been described, various methods of using the identification tag will now be presented. Various possible methods of use will be described. The methods described may be applicable to the embodiments described above in relation to FIGS. 1-13, but it is understood that the method can be carried out with other suitable systems and arrangements. Moreover, the method may include other steps that are not described, and in fact, the methods are not limited to including every step described herein. Moreover, the described steps are not limited to the particular chronological order described. Indeed, some of the steps may be performed in a different order than what is described and/or at least some of the steps described can occur simultaneously.

A user can personalize the identification tag 10 in any suitable manner to distinguish that user from another user. For instance, a user can remove one or more of the character elements 62 from the sheet 60, and the user can apply the removed character elements 62 to the identifier tag 10. For purposes of this example, the user can apply the character elements 62 to the window element 40.

The window element 40 and the identification tag 10 can be brought together such that the window element 40 is retainably engaged by the identification tag 10. In this example, the window element 40 can be inserted into the recess 18 in the main body element 12 of the identification tag 10. The window element 40 and/or the main body element 12 can be manipulated by the user as needed to achieve the desired retainable engagement.

The identification tag 10 and a personal linen, such as a towel, can be brought together. The identification tag 10 and/or the personal linen can be manipulated so that the identification tag 10 is attached to the personal linen. In one implementation, the identification tag 10 can be attached to an attachment point on the personal linen. In some arrangements, the attachment point can be a pre-existing structure or feature of the personal linen. As an example, referring to FIG. 11, a personal linen 56 (e.g. a towel 57) include an information tag 58. The information tag 58 can indicate the manufacturer's name, the country of origin, material of the linen, instructions for use, instructions for care and/or other information. The information tag 58 is often provided in the form of a loop defining a passage 66.

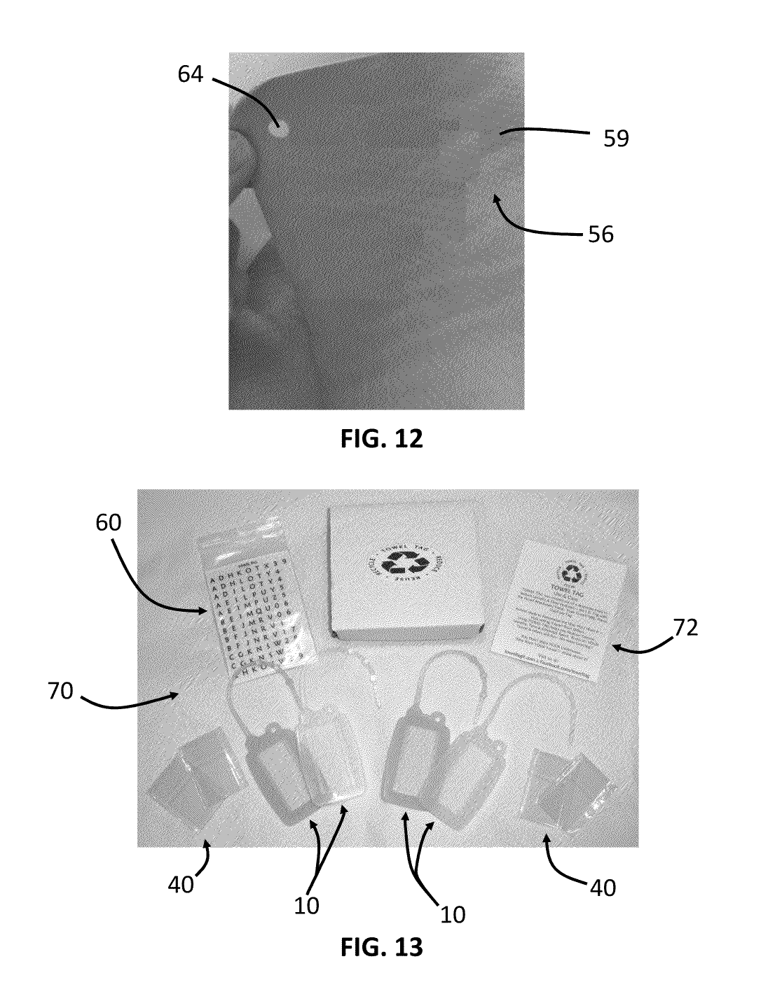

In some arrangements, the personal linen may not provide a suitable attachment point. In such case, the personal linen can be adapted to provide an attachment point. FIG. 12 shows an example in which the personal linen 56 (e.g. a sports towel 59) is adapted by forming a hole 64 in the body of the personal linen 56. The hole 64 can be formed in any suitable manner, such as by using a hole punch or other suitable tool.

The attachment element 26 of the identification tag 10 can be brought into engagement with the information tag 58. For instance, the strap 28 of the identification tag 10 can be inserted into the passage 66 defined by the information tag 58 (or the strap 28 can be inserted into the hole 64). After passing through the passage, the distal end 32 of the strap 28 can be fed into the hole 34 of the identification tag 10. As the strap 28 is being fed through the hole 34, an enlarged element 36 may be encountered. A user can press or push the enlarged element 36 through the hole 34. Once at least one enlarged element 36 has been passed through the hole 34, the identification tag 10 can be in retainable engagement with the personal linen 56. An example of such an arrangement is shown in FIG. 11. It will be understood that similar actions can be applied to the arrangements of the identification tag 10 shown in FIGS. 9 and 10 and/or the arrangements of the attachment point of the personal linen 56 shown in FIG. 12.

The attachment can be adjusted by continuing to feed the strap 28 through the hole 34, pushing additional enlarged elements 36 through the hole 34 as needed. Of course, the attachment can be adjusted in the opposite direction in which the strap 28 can be retracted through the hole 34, pushing any enlarged elements 36 through the hole 34 as needed.

As a result of such an arrangement, the personal linen 56 is identified as being associated with a particular user by the identification tag 10. The identification tag 10 can remain attached to the personal linen 56 for any suitable period of time. The identification tag 10 can remain attached to the personal linen 56 while the personal linen 56 is being used. The identification tag 10 does not interfere with a person's use of the personal linen 56. The identification tag 10 can be used in close contact with human skin. When the personal linen 56 requires cleaning, the identification tag 10 can be removed from the personal linen 56 by retracting the strap 26 through the hole 34, pushing the enlarged elements 36 through as necessary. After the personal linen 56 is cleaned, the identification tag 10 can be reattached to the personal linen 56 as described above.

Arrangements described herein can provide numerous benefits. Examples of various benefits that may be realized will be described herein. In one or more implementations, the identification tag can be readily attached and removed from a person linen without damaging or altering the personal linen itself. The identification tag can allow people to readily identify the owner of the personal linen. The identification tag can be personalized to fit the preferences of an individual user. The identification tag can ensure that the same person uses the same personal linen more than one time without the personal linen being shared by other people. As a result, the transmission of bacteria, germs, viruses, diseases, infections and/or parasites between persons can be minimized.

The connection between the identification tag and the personal linen can be a soft connection. That is, the connection avoids the use of hard plastic, metal alligator clips and/or other hard or rough connectors that can cause uncomfortable and/or abrasive skin contact during use. Thus, the identification tag can be safe for close skin contact. Further, arrangements described herein can enable the use of a personal linen while the identification tag is attached thereto. Still further, arrangements described herein can allow for multi-venue use. Arrangements described herein can lead to appreciable time savings because fewer loads of laundry will need to be washed and less frequently. Moreover, the consumption of detergents, water and energy can be minimized. Arrangements described herein can also reduce the costs of utility bills.

It should also be noted that arrangements described herein can be used for other purposes in addition to identifying personal linens. For instance, an identification tag can be used to mark a baby stroller at an event or venue (e.g. a theme park). In such case, the identification tag can be attached, for example, to the handle bar of the baby stroller or other suitable attachment point.

The identification tag can be used in various environments in which a plurality of people are using personal linens. For instance, arrangements herein can be used in a house, apartment, condo, college dormitories, hotels, resorts, businesses, classrooms, day care centers, campgrounds, fitness clubs, athletic facilities (e.g. locker rooms). The identification tags can also be used to separate personal linens for humans from personal linens for pets. Further, one or more personal linens can be marked for guests, thereby designating a personal linen for their exclusive use.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

Aspects described herein can be embodied in other forms and combinations without departing from the spirit or essential attributes thereof. Thus, it will of course be understood that embodiments are not limited to the specific details described herein, which are given by way of example only, and that various modifications and alterations are possible.

What is claimed is:

1. An identification tag comprising:
a main body element, the main body element including a recess, the recess opening to a side of the main body element and extending into a thickness of the main body element, the recess including a sidewall; and
an attachment element operatively connected to the main body element, the attachment element being configured to attach to itself or to the main body element so as to form a loop;
a window element retainably engaged in the recess.

2. The identification tag of claim 1, wherein the attachment element is a separate piece from the main body element.

3. The identification tag of claim 1, wherein the attachment element and the main body element are a unitary structure.

4. The identification tag of claim 1, wherein the attachment element includes a strap with at least one enlarged element provided thereon.

5. The identification tag of claim 1, wherein the attachment element includes a strap configured with connectors to allow the strap to be attached to itself.

6. The identification tag of claim 1, wherein the sidewall is a first sidewall, and further including a second sidewall, wherein the first and second sidewalls are configured to retainably engage the window element.

7. The identification tag of claim 6, wherein the first and second sidewalls are substantially parallel to each other.

8. The identification tag of claim 1, wherein the sidewall includes a receiving channel, and wherein a portion of the window element is received in the receiving channel.

9. The identification tag of claim 1, wherein the sidewall includes an inward protrusion, and whereby the window element is retainably engaged in the recess at least in part by the protrusion.

10. The identification tag of claim 1, further including one or more character elements removably attached to the window element or a bottom surface of the recess.

11. A linen identification system comprising:
a personal linen; and
an identification tag, the identification tag including:
a main body element, the main body element including a recess, the recess opening to a side of the main body element, the recess extending into a thickness of the main body element, the recess including a sidewall;
an attachment element operatively connected to the main body element, the attachment element being configured to attach to itself or to the main body element so as to form a loop; and
a window element retainably engaged in the recess,
the identification tag being attached to the personal linen by the attachment element, the attachment element engaging an attachment point of the personal linen.

12. The linen identification system of claim 11, wherein the attachment point is an information tag provided on the personal linen.

13. The linen identification system of claim 12, wherein the information tag is in the form of a loop defining a passage, wherein the attachment element is received in the passage.

14. The linen identification system of claim 11, wherein the attachment point is a hole provided in the personal linen.

15. The linen identification system of claim 11, wherein the personal linen is a towel.

16. The linen identification system of claim 11, wherein the attachment element is a separate piece from the main body element.

17. The linen identification system of claim 11, further including one or more character elements removably attached to the window element or a bottom surface of the recess.

18. A linen identification kit comprising:
a sheet including a plurality of character elements thereon, the character elements removably attached to the sheet; and
an identification tag including:
a main body element, the main body element including a recess, the recess opening to a side of the main body element, the recess extending into a thickness of the main body element, the recess including a sidewall,; and
an attachment element operatively connected to the main body element, the attachment element being configured to attach to itself or to the main body element so as to form a loop,
the character elements being configured to be removably attached to the identification tag.

19. The linen identification kit of claim 18, further including a window element, wherein the recess is configured to retainably engage the window element.

20. The linen identification kit of claim 18, wherein the identification tag is a first identification tag, and wherein the linen identification kit further includes a second identification tag, wherein the second identification tag includes:
a main body element, the main body element including a recess, the recess opening to a side of the main body element, the recess extending into a thickness of the main body element, the recess including a sidewall,; and
an attachment element operatively connected to the main body element, the attachment element being configured to attach to itself or to the main body element so as to form a loop,
wherein the second identification tag is different from the first identification tag.
